(19) United States
(12) Patent Application Publication
(10) Pub. No.: US 2008/0183822 A1
(43) Pub. Date: Jul. 31, 2008

(54) EXCLUDING A GROUP MEMBER FROM RECEIVING AN ELECTRONIC MESSAGE ADDRESSED TO A GROUP ALIAS ADDRESS

(76) Inventors: Yigang Cai, Naperville, IL (US); Bill Xiang Yu Qian, QuinDao (CN); Alexander Aihao Yin, QingDao (CN)

Correspondence Address: DUFT BORNSEN & FISHMAN, LLP, 1526 SPRUCE STREET, SUITE 302, BOULDER, CO, 80302, US

(21) Appl. No.: 11/627,019

(22) Filed: Jan. 25, 2007

(51) Int. Cl. G06F 15/16

(52) U.S. Cl. 709/206

(57) ABSTRACT

Systems and methods are provided for excluding one or more electronic message addresses associated with a group alias address from receiving an electronic message. A method of the invention comprises receiving exclusion criteria associated with the electronic message. The exclusion criteria identify a type of group member to be excluded from receiving the electronic message. The method further comprises identifying group members associated with the group alias address. The method further comprises processing the exclusion criteria to identify one or more excluded group members to exclude from receiving the electronic message and one or more included group members to receive the electronic message. The method further comprises blocking the excluded group members from receiving the electronic message.

### BACKGROUND OF THE INVENTION

1. Field of the Invention

The invention is related to the field of communications, and in particular, to systems and methods for excluding one or more electronic message addresses associated with a group alias address from receiving an electronic message based on exclusion criteria.

2. Statement of the Problem

Group alias addresses are commonly used for communicating. Group alias addresses, also referred to as aliases, reflectors, mailing lists or distribution lists, allow a sender of an email (or other types of electronic messages, such as a short message service “SMS” message, a multimedia message service “MMS” message, or an instant messaging “IM” message) to specify a single address (i.e., the group alias address) as a recipient of the email. The group alias address is associated with multiple individual email addresses of group members. Groups often have an underlying affiliation, such as employees of the same department, geographical location, building location, individuals having the same or similar hobby, etc.

Upon receipt of the email having a group alias address, an email server identifies email addresses of individuals associated with the group alias address, and transmits the email to the individual email addresses of the group members. Typically, an email displays the group alias address instead of the individual email addresses of the group members. A recipient is not typically shown the identities of the other members of the group receiving the email. The group alias address allows a sender to send an email to many different recipients without manually entering the email addresses of each recipient, or even knowing the email address of each recipient.

A problem arises when a sender desires to exclude one or more group members from receiving email addressed to the group alias address. Because of the structure of group alias addresses, an email to a group alias address will be sent to each group member associated with the group alias address. Therefore, a sender can't presently exclude a group member associated with the group alias address from receiving the email unless the sender knows the group member's email address.

Senders presently exclude one or more group members by cutting and pasting all of the email addresses associated with the group alias address and removing the excluded group members. This solution is viable only if the sender has access to the individual email addresses of the group members. Further, this solution eliminates the efficiency of using a group alias address as a recipient for a group email. If the list of group members is large or the number of excluded group members is large, then the process becomes burdensome. If the sender wants to exclude a certain type of group member from the list, such as all members of a certain department, then the user may not be able to ascertain which individuals to remove just by looking at the list of email addresses.

Thus, improved solutions are needed for group alias addresses to allow senders to exclude one or more group members from receiving an email.

### SUMMARY OF THE SOLUTION

The invention solves the above problems and other problems by providing systems and methods for excluding one or more electronic message addresses associated with a group alias address from receiving an electronic message (e.g., an email). According to a first exemplary embodiment of the invention, a sender of an electronic message addressed to a group alias address provides exclusion criteria that identify one or more of the group members associated with the group alias address. The exclusion criteria may identify group members based on different types of information associated with the electronic message addresses of the group members. Advantageously, a sender may compose an electronic message addressed to a group alias address, and exclude group members based on the exclusion criteria matching some of the group members. The sender no longer needs to generate a list of group members and manually remove selected group members. The sender may exclude group members from receiving the electronic message when the sender does not know the individuals' electronic message address or identity.

The first exemplary embodiment of the invention comprises an electronic message server for processing electronic messages. The electronic message server comprises an interface system adapted to receive an electronic message addressed to a group alias address and receive exclusion criteria associated with the electronic message. The electronic message server further comprises a processing system coupled to the interface system and adapted to identify group members associated with the group alias address. The processing system is further adapted to process the exclusion criteria to identify one or more excluded group members to exclude from receiving the electronic message and one or more included group members to receive the electronic message. The electronic message server is further adapted to block the one or more excluded group members from receiving the electronic message.

A second exemplary embodiment of the invention comprises a method for processing an electronic message. The method comprises receiving exclusion criteria associated with the electronic message. The method further comprises identifying group members associated with the group alias address. The method further comprises processing the exclusion criteria to identify one or more excluded group members to exclude from receiving the electronic message and one or more included group members to receive the electronic message. The method further comprises blocking the one or more excluded group members from receiving the electronic message.

A third exemplary embodiment of the invention comprises a method for processing electronic messages. The method comprises receiving user input specifying a group alias address for an electronic message. The group alias address identifies group members associated with the group alias address. The method further comprises receiving user input specifying exclusion criteria associated with the electronic message. The exclusion criteria identify one or more excluded group members to be excluded from receiving the electronic message. The method further comprises transmitting the electronic message addressed to the group alias address to an electronic message server and transmitting the exclusion criteria to the electronic message server.

The invention may include other exemplary embodiments described below.

### DESCRIPTION OF THE DRAWINGS

The same reference number represents the same element or same type of element on all drawings.

FIG. 1 illustrates a system for processing an electronic message in an exemplary embodiment of the invention.

FIG. 2 illustrates a method for composing an electronic message in an exemplary embodiment of the invention.

FIG. 3 illustrates a graphical user interface (GUI) of an electronic message client application in an exemplary embodiment of the invention.

FIG. 4 illustrates a method for transmitting an electronic message in another exemplary embodiment of the invention.

FIG. 5 illustrates a method for querying a directory server to determine excluded group members in another exemplary embodiment of the invention.

FIG. 6 illustrates a method for removing exclusion criteria from an electronic message in another exemplary embodiment of the invention.

FIG. 7 illustrates a method for replacing the group alias address in a recipient field of an electronic message with the individual electronic message addresses of the recipients of the electronic message in another exemplary embodiment of the invention.

FIG. 8 illustrates an electronic message generated by the method of FIG. 7 in which the group alias address in the recipient field is replaced by the individual electronic message addresses of the recipients.

FIG. 9 illustrates an electronic message addressed to a group alias address in which the recipient field of the electronic message displays the group alias address.

FIG. 10 illustrates a method for generating a list of group members of an electronic message based on exclusion criteria and allowing a user to select one or more of the group members to exclude from receiving the electronic message in another exemplary embodiment of the invention.

### DETAILED DESCRIPTION OF THE INVENTION

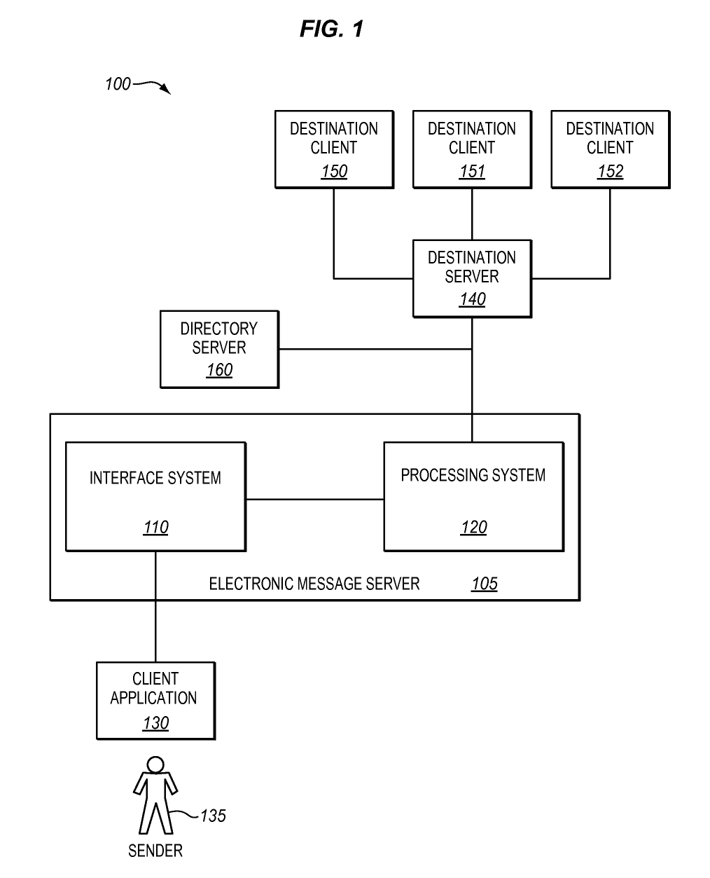

FIGS. 1-10 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below may be combined in various ways to form multiple variations of the invention. As a result, the invention is not limited to the specific embodiments described below, but only by the claims and their equivalents.

FIG. 1 illustrates a network 100 in an exemplary embodiment of the invention. Network 100 comprises an electronic message server 105 for processing an electronic message. Electronic message server 105 may process a variety of electronic messages, including email, instant messages, SMS messages, MMS messages or any type of equivalent electronic message. Electronic message server 105 includes an interface system 110 for interfacing with a client application 130. Client application 130 is a software application adapted to provide electronic message services to sender 135, including sending and/or receiving electronic messages. Client application 130 may be a self-contained application operating on a standalone computing system, such as a personal computer, a PDA, a cellphone or any other computing device. Client application 130 may alternatively be a web page generated by interface system 110 and available to sender 135 through a browser on a web enabled device, such as a personal computer, cellphone, PDA, etc. Sender 135 may generate an electronic message using client application 130, and client application 130 may transmit the electronic message to interface system 110.

Electronic message server 105 also includes a processing system 120 communicatively coupled to interface system 110. Processing system 120 refers to a single processing device or a group of inter-operational processing devices. The operation of processing system 120 may be controlled by instructions executable by processing system 120. Some examples of instructions are software, program code, and firmware. Processing system 120 may be any type of processing system adapted to function as an electronic message server. Processing system 120 receives an electronic message from interface system 110 and transmits the electronic message to a destination server 140 of network 100 communicatively coupled to processing system 120. Destination server 140 may then transmit the electronic message to one or more destination clients 150-152 of network 100. Processing system 120 may also receive electronic messages from interface system 110 and transmit the electronic messages to destination clients 150-152 which interface with processing system 120 for electronic message services. Processing system 120 may also be adapted to operate as a destination server for electronic messages generated by other electronic message servers. Network 100 may optionally include directory server 160 for providing directory information to processing system 120.

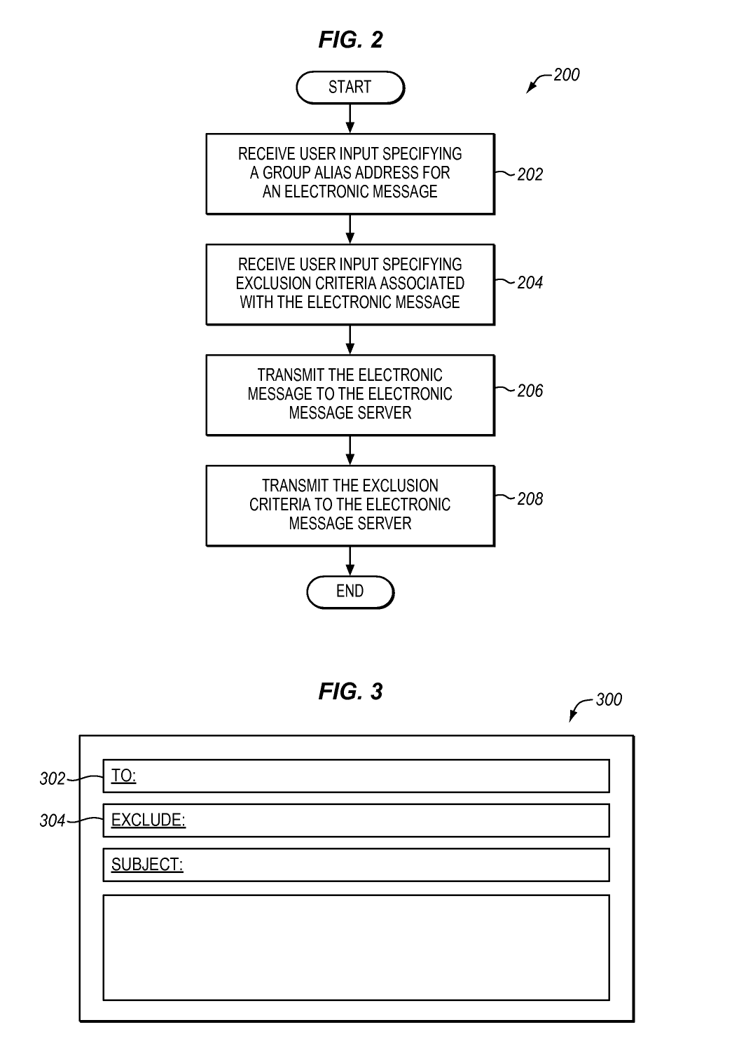

An electronic message client application (e.g., client application 130) adapted to support exclusion criteria may be used to interface with electronic message server 105. FIG. 2 illustrates a method 200 for composing an electronic message in an exemplary embodiment of the invention. The steps of method 200 are described with reference to network 100 illustrated in FIG. 1. The steps of method 200 are not all-inclusive, and may include other steps not shown for the sake of brevity. Method 200 may be served by client application 130 of FIG. 1.

In step 202, client application 130 receives user input specifying a group alias address for an electronic message composed by sender 135. The group alias address is associated with a plurality of group members, where each group member has a corresponding electronic message address. FIG. 3 illustrates a GUI 300 of an electronic message client application (e.g., client application 130) in an exemplary embodiment of the invention. The sender 135 may enter the group alias address in recipient field 302 of GUI 300.

In step 204, client application 130 receives user input specifying exclusion criteria associated with the electronic message. The exclusion criteria identify a type of group member to be excluded from receiving the electronic message. Exclusion criteria include information associated with the electronic message that identifies an electronic message address, of one or more group members, not specified in the electronic message. The exclusion criteria may be a corporate department, a physical location, a name, a job title, etc. Those of ordinary skill in the art will readily recognize a variety of personal information typically stored in association with an electronic message address that may be used as appropriate exclusion criteria. Sender 135 may enter the exclusion criteria in exclusion field 304 of GUI 300.

The exclusion criteria may be included in the electronic message transmitted to interface system 110 by client application 130. For example, the exclusion criteria may be included in a header or the mailtoURL of the electronic message (e.g., mailtoURL:sales@mydomain?exclude={exclude criteria}). Alternatively, the exclusion criteria may be transmitted to interface system 110 by client application 130 as a separate message from the electronic message as subsequently described.

In step 206, client application 130 transmits the electronic message to interface system 110. In step 208, client application 130 transmits the exclusion criteria to interface system 110. The exclusion criteria may be a part of the electronic message transmission, or may be transmitted as a separate communication between client application 130 and interface system 110.

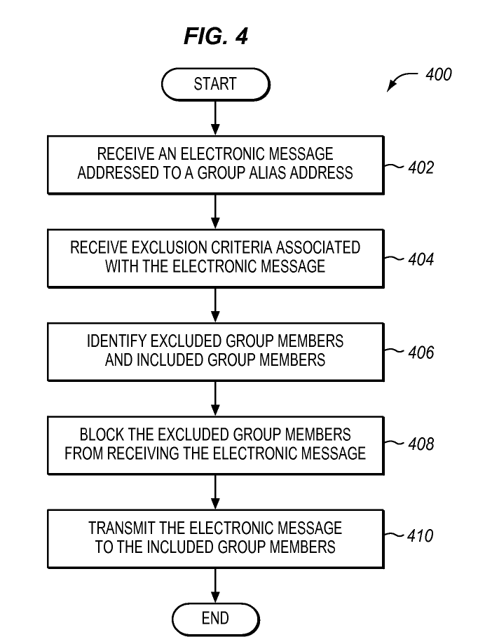

FIG. 4 illustrates a method 400 for transmitting an electronic message in an exemplary embodiment of the invention. The steps of method 400 are described with reference to network 100 illustrated in FIG. 1. The steps of method 400 are not all-inclusive, and may include other steps not shown for the sake of brevity.

In step 402, interface system 110 receives the electronic message addressed to the group alias address from client application 130. In step 404, interface system 110 receives the exclusion criteria associated with the electronic message from client application 130.

In step 406, processing system 120 processes the exclusion criteria to identify excluded group members and included group members of the group alias address. The included group members comprise group members of the group alias address that are allowed to receive the electronic message. The excluded group members comprise group members of the group alias address that are not allowed to not receive the electronic message. The excluded group members are determined by selecting group members associated with the group alias address which have personal information corresponding with the exclusion criteria. For example, assume that the group members associated with the group alias address each have assigned sales zones. Assume that the electronic message addresses associated with the group alias address have the following stored information:

| Name | Electronic message Address | Sales Zone |
|---|---|---|
| Bob | bob@mydomain | 1 |
| Sue | sue@mydomain | 1 |
| Kim | kim@mydomain | 2 |
| Tim | tim@mydomain | 3 |
| Matt | matt@mydomain | 3 |

Assume further that the exclusion criteria specify sales zone 3. Processing system 120 identifies group members Tim and Matt of sales zone 3 to be excluded from receiving the electronic message. The included group members are identified as Bob, Sue and Kim.

In step 408, processing system 120 blocks the excluded group members from receiving the electronic message. In step 410, processing system 120 transmits the electronic message to the included group members.

The information used to identify the excluded group members may be stored locally within processing system 120 or electronic message server 105. If processing system 120 is unable to identify the excluded group members based on the provided exclusion criteria, then processing system 120 queries a directory server 160 to determine the excluded group members (and their electronic message addresses). The directory server 160 may be external to electronic message server 105.

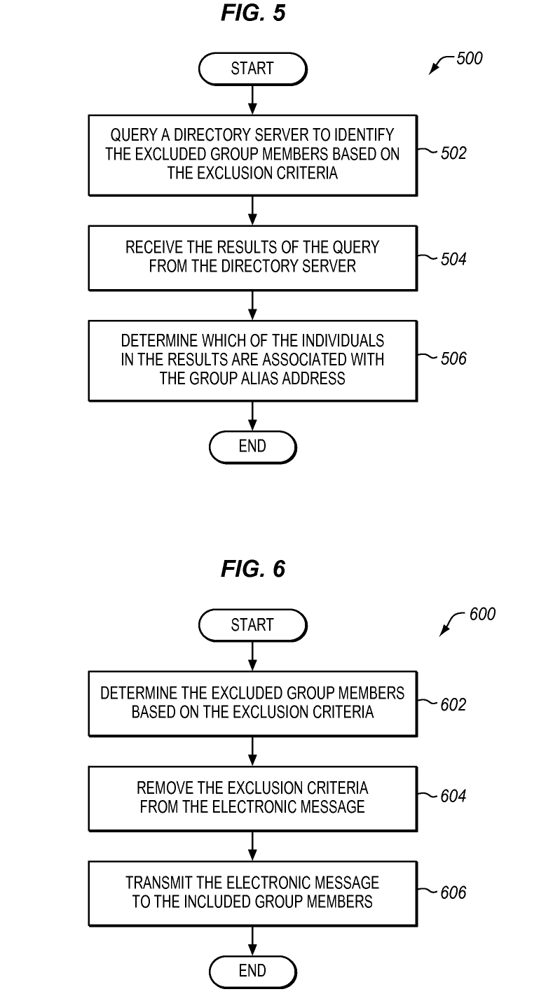

FIG. 5 illustrates a method 500 for querying a directory server to determine the excluded group members in another exemplary embodiment of the invention. The steps of method 500 are described with reference to network 100 illustrated in FIG. 1. The steps of method 500 are not all-inclusive, and may include other steps not shown for the sake of brevity.

In step 502, processing system 120 queries directory server 160 based on the exclusion criteria to identify the excluded group members. Directory server 160 may be a Lightweight Directory Access Protocol (LDAP) server. The query may specify the exclusion criteria, and request identification of any individuals and/or electronic message addresses associated with the exclusion criteria.

In step 504, processing system 120 receives the results of the query from the directory server. The results of the query may include individuals and/or electronic message addresses that are not associated with the group alias address.

In step 506, processing system 120 determines which individuals and/or electronic message addresses included within the results of the query to directory server 160 are associated with the group alias address. Processing system 120 may compare each individual (or the corresponding electronic message address of each group member) in the results of the query to each electronic message address associated with the group alias address to determine which electronic message addresses included within the results are associated with the group alias address. The intersection of the results of the query to directory server 160 and the group members associated with the group alias address become the excluded group members. Processing system 120 may then block these group members (and their corresponding electronic message addresses) from receiving the electronic message.

An example is provided herein to illustrate the operation of method 500 of FIG. 5. Assume that the group alias address sales@mydomain has group members identified above as discussed in regard to FIG. 4. Assume further that the exclusion criteria specify employees on the second floor of a building. Processing system 120 queries directory server 160 to identify employees (and/or their electronic message addresses) on the second floor of the building. Assume further that processing system 120 receives the following results to the query to directory server 160:

| Name | Electronic Message Address | Floor |
|---|---|---|
| Sue | sue@mydomain | Second |
| Brett | brett@mydomain | Second |
| Don | don@mydomain | Second |
| Tiffany | tiffany@mydomain | Second |
| Matt | matt@mydomain | Second |

The results of the query to directory server 160 include five individuals and their corresponding electronic message addresses. The results of the query to directory server 160 include individuals not associated with the group alias address. Processing system 120 compares the individuals and/or their corresponding electronic message addresses included within the results to directory server 160 to the list of group members and/or their corresponding electronic message addresses of the group alias address to determine which individuals are found in both sets of data. The electronic message addresses contained within both sets of data (i.e., the intersection) become the excluded group members.

In the described example, the electronic message addresses of Sue (sue@mydomain) and Matt (matt@mydomain) are found in both data sets. These two electronic message addresses become the excluded group members. The electronic message addresses of Brett (brett@mydomain), Don (don@mydomain), and Tiffany (tiffany@mydomain) are not found in the list of group members associated with the group alias address, and are disregarded. Processing system 120 transmits the electronic message to the included group members. Thus, Bob (bob@mydomain), Kim (kim@mydomain), and Tim (tim@mydomain) receive the electronic message addressed to the group alias address, while Sue (sue@mydomain) and Matt (matt@mydomain) do not receive the electronic message.

If the exclusion criteria are included within the headers of the electronic message, then the exclusion criteria may be viewable by any of the recipients of the electronic message. It may be desirable for a sender 135 of the electronic message and/or electronic message server 105 to hide the exclusion criteria (and the identity of group members excluded from receiving the electronic message) from recipients of the electronic message. FIG. 6 illustrates a method 600 for removing exclusion criteria from an electronic message in an exemplary embodiment of the invention. The steps of method 600 are described with reference to network 100 illustrated in FIG. 1. The steps of method 600 are not all-inclusive, and may include other steps not shown for the sake of brevity.

In step 602, processing system 120 determines the excluded group members (and their electronic message addresses) based on the exclusion criteria. The exclusion criteria may be included in a header of the electronic message. For example, assume that the headers of the electronic message are as follows:

| | |
|---|---|
| MailToUrl: | all-employees@mydomain?exclude=(dept=Research) |
| Sender: | joe@mydomain |
| Date: | 01/01/2007 12:00:00 A.M. |
| Subject: | Employee Fire Drill |

In step 604, processing system 120 removes the exclusion criteria from the electronic message (e.g., removes or modifies the header containing the exclusion criteria). Thus, for the described example, the headers may be as follows:

| | |
|---|---|
| MailToUrl: | all-employees@mydomain |
| Sender: | joe@mydomain |
| Date: | 01/01/2007 12:00:00 A.M. |
| Subject: | Employee Fire Drill |

In step 606, processing system 120 transmits the electronic message to the included group members. Thus, group members specified by the all-employees group alias address will receive the electronic message. However, employees designated as members of the research department will not receive the electronic message. The employees receiving the electronic message are not aware that the research department was excluded from receiving the electronic message.

In prior art electronic message systems, the recipient field viewable by a recipient of an electronic message addressed to a group alias address displays the group alias address. Usually, the identity of other recipients is unavailable and/or unknown to any of the recipients. The identities of other recipients may be useful in some situations where group members have been excluded from receiving the electronic message. For example, when replying to an electronic message, a recipient may want to know who originally received the electronic message. However, it may not be desirable in cases where the recipient field is significantly large to include the identity of all recipients. In cases with smaller recipient lists, sender 135 may desire to allow the recipients to see who is receiving the electronic message. One particular instance is when a significant number of individuals associated with the group alias address have been excluded from receiving the electronic message.

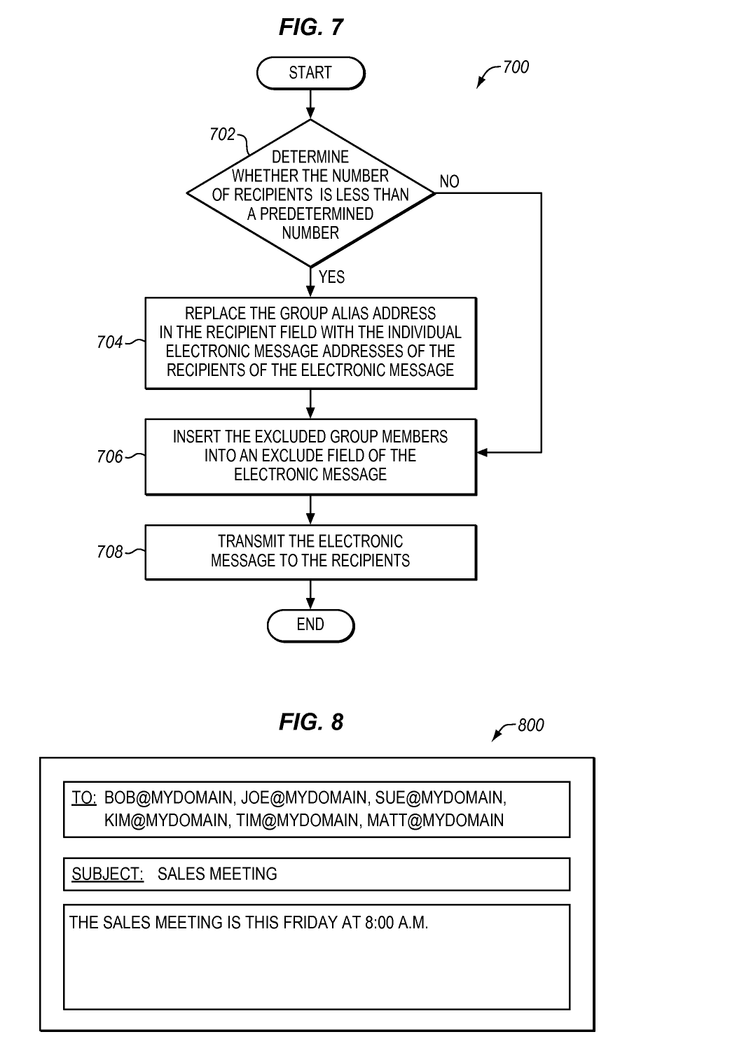

FIG. 7 illustrates a method 700 for replacing the group alias address in a recipient field of an electronic message with the individual electronic message addresses of the recipients of the electronic message in another exemplary embodiment of the invention. The steps of method 700 are described with reference to electronic message server 105 illustrated in FIG. 1. The steps of method 700 are not all-inclusive, and may include other steps not shown for the sake of brevity.

In step 702, processing system 120 determines whether the number of included group members is less than a predetermined number. The predetermined number may be statically defined or user defined within processing system 120. The predetermined number may also be indicated within a header or user defined field of the electronic message.

Assume for example that the recipient list of the electronic message is as follows, and that the predetermined number is ten.

Recipient List - sales-south@mydomain

| | |
|---|---|
| Bob | bob@mydomain |
| Joe | joe@mydomain |
| Sue | sue@mydomain |
| Kim | kim@mydomain |
| Tim | tim@mydomain |
| Matt | matt@mydomain |

In step 704, if the number of included group members is less than the predetermined number, then processing system 120 replaces the group alias address in the recipient field of the electronic message with the individual electronic message addresses of included group members. In the described example, the number of recipients is six. Because the number of included group members is less than the predetermined number, processing system 120 replaces the group alias address in the recipient field of the electronic message with the individual electronic message addresses of the included group members.

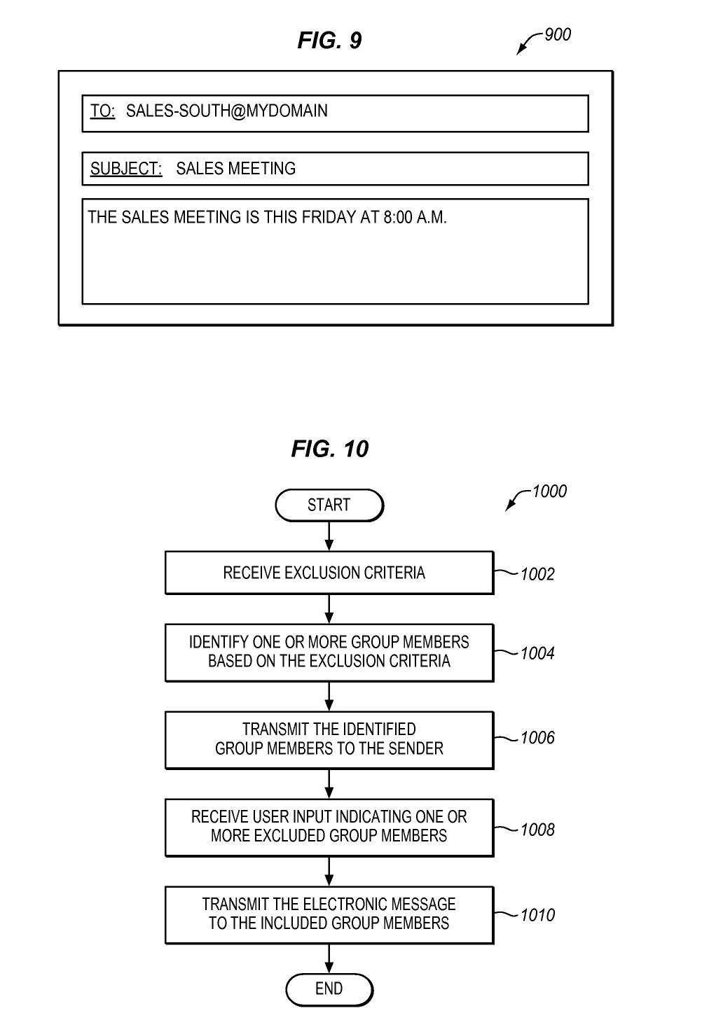

FIG. 8 illustrates an electronic message 800 generated in step 704 in which the group alias address in the recipient field has been replaced by the individual electronic message addresses of the included group members. If the number of included group members is greater than the predetermined number, then processing continues in step 706, and the recipient field displays the group alias address as illustrated by electronic message 900 in FIG. 9.

Optionally, sender 135 may want to display the excluded group members to recipients of the electronic message. In optional step 706, processing system 120 inserts the excluded group members into an exclude field of the electronic message. The exclude field is then displayed to a recipient within a GUI of the recipient's electronic message client application. In step 708, processing system 120 transmits the electronic message to the included group members.

In some circumstances, sender 135 may want to send the electronic message to certain group members associated with a group alias address, but those group members may not have a common characteristic associated with their electronic message addresses to use as exclusion criteria. For example, assume that sender 135 wants to send an electronic message to a group alias address associated with all employees, but wants to exclude selected employees of a certain department, while sending the electronic message to other employees of the same department. One exemplary embodiment of the invention allows sender 135 to exclude the selected employees, while sending the electronic message to the remaining employees associated with the group alias address.

FIG. 10 illustrates a method 1000 for generating a list of selected group members associated with a group alias address based on exclusion criteria and allowing a user to select one or more of the group members to exclude from receiving the electronic message in another exemplary embodiment of the invention. The steps of method 1000 are described with reference to network 100 illustrated in FIG. 1. The steps of method 1000 are not all-inclusive, and may include other steps not shown for the sake of brevity.

In step 1002, interface system 110 receives exclusion criteria from client application 130 operated by sender 135. For example, the exclusion criteria may comprise a selected department within a company. In step 1004, processing system 120 identifies one or more group members associated with the group alias address based on the exclusion criteria. The identified group members are selected from the group members associated with the group alias address. For example, processing system 120 may identify group members associated with the department specified by the exclusion criteria.

In step 1006, processing system 120 transmits the information regarding the identified group members to client application 130 operated by sender 135. Client application 130 may display the identified group members (and/or their corresponding electronic message address) in a graphical user interface (GUI), allowing sender 135 to select one or more of the identified group members to exclude from receiving the electronic message. The user may then select one or more of the group members displayed in the GUI to exclude from receiving the electronic message.

In step 1008, processing system 120 receives user input from sender 135 indicating the excluded group members. The user input may be transmitted by client application 130 to processing system 120 in the electronic message via interface system 110, or may be transmitted as part of a separate communication from client application 130 to interface system 110. For example, client application 130 may allow sender 135 to generate an electronic message, designate the group alias address, select the exclusion criteria, and select the excluded group members through multiple windows, steps, forms, or interfaces. If the electronic message is generated in multiple steps, then client application 130 may transmit the user input for each step before the display of the instructions for the next step. Processing system 120 may transmit the electronic message after sender 135 has completed all of the steps. In step 1010, processing system 120 transmits the electronic message to the included group members.

The user input that processing system 120 receives from sender 135 may also indicate whether the electronic message is to display the group alias address or the individual electronic message addresses of the included group members. This option may allow sender 135 to designate the display of the individual electronic message addresses of the included group members regardless of whether the number of included group members is less than a predetermined number as described in method 500. For example, a checkbox in client application 130 may allow sender 135 to designate this option. The value of the checkbox may be transmitted by client application 130 to processing system 120 as a parameter of the electronic message. The electronic message addressees of the group members will be displayed in the electronic message if sender 135 selects this option.

An example is provided herein to illustrate the operation of method 1000. Assume for example that sender 135 creates a new electronic message using client application 130. Assume sender 135 further identifies the recipient address as all-employees@mydomain. Assume further that sender 135 indicates exclusion criteria within an exclusion field of client application 130. After sender 135 completes the electronic message, client application 130 transmits the exclusion criteria to interface system 110. Assume that the exclusion criteria received by interface system 110 specifies group members of the all-employees group alias address which are members of the engineering department. Processing system 120 identifies group members (and/or their corresponding electronic message addresses) associated with the engineering department. Assume the identified list is as follows:

Engineering Department

| | |
|---|---|
| Steve | steve@mydomain |
| Robert | robert@mydomain |
| Carol | carol@mydomain |
| Roger | roger@mydomain |
| Louise | louise@mydomain |

Processing system 120 transmits the identified list of group members to client application 130. Client application 130 displays the identified list of group members in a GUI to sender 135. Assume further that the GUI displays a checkbox next to each of the identified group members on the list. Client application 130 allows sender 135 to select one or more of the identified group members on the list to be excluded from receiving the electronic message. Sender 135 selects the excluded group members by activating the checkbox next to the name of the selected group members. Assume that sender 135 selects the electronic message addresses of Roger (roger@mydomain) and Steve (steve@mydomain). After sender 135 selects the electronic message addresses of Roger and Steve, the excluded electronic message addresses are embedded within an exclude field of the electronic message.

When sender 135 completes composing the electronic message, the client application 130 transmits the electronic message to interface system 110. Processing system 120 translates the recipient field containing the all-employees group alias address into a list of electronic message addresses associated with the group alias address. Processing system 120 removes the excluded group members from the list. In the described example, processing system 120 will remove the electronic message addresses of Roger and Steve from the list of electronic message addresses associated with the group alias address. Processing system 120 will then transmit the electronic message to the remaining electronic message addresses included in the list of electronic message addresses associated with the group alias address. Using method 1000, a user may identify electronic message addresses associated with a group alias address according to selected exclusion criteria, and exclude one or more of the identified electronic message addresses from receiving the electronic message addressed to the group alias address.

Although specific embodiments were described herein, the scope of the invention is not limited to those specific embodiments. The scope of the invention is defined by the following claims and any equivalents thereof.

We claim:

1. An electronic message server for processing electronic messages, the electronic message server comprising:
an interface system adapted to receive an electronic message addressed to a group alias address, and to receive exclusion criteria associated with the electronic message; and
a processing system coupled to the interface system and adapted to:
identify group members associated with the group alias address;
process the exclusion criteria to identify at least one excluded group member to exclude from receiving the electronic message and at least one included group member to receive the electronic message; and
block the at least one excluded group member from receiving the electronic message.

2. The electronic message server of claim 1 wherein the processing system is further adapted to transmit the electronic message to the at least one included group member.

3. The electronic message server of claim 1 wherein the processing system is further adapted to query a directory server based on the exclusion criteria to identify the at least one excluded group member.

4. The electronic message server of claim 1 wherein the processing system is further adapted to:
remove the exclusion criteria from the electronic message; and
transmit the electronic message to the at least one included group member.

5. The electronic message server of claim 1 wherein:
the electronic message comprises a recipient field;
the at least one included group member having an individual electronic message address; and
the processing system is further adapted to replace the group alias address in the recipient field of the electronic message with the individual electronic message address of the at least one included group member.

6. The electronic message server of claim 1 wherein:
the electronic message comprises a recipient field;
the at least one included group member having an individual electronic message address; and
the processing system is further adapted to:
determine whether the at least one included group member includes less than a predetermined number of group members; and
replace the group alias address in a recipient field of the electronic message with the individual electronic message address of the at least one included group member in response to a determination that the at least one included group member includes less than the predetermined number of group members.

7. The electronic message server of claim 1 wherein the electronic message comprises an exclude field for displaying an electronic message address of the at least one excluded group member, and the processing system is further adapted to:
insert the electronic message address of the at least one excluded group member into the exclude field.

8. The electronic message server of claim 1 wherein each group member has an individual electronic message address, and the processing system is further adapted to:
identify at least one group member from the group members associated with the group alias address based on the exclusion criteria;
transmit the at least one group member to a sender of the electronic message; and
receive user input from the sender specifying the at least one excluded group member which is selected from the at least one group member transmitted to the sender.

9. A method for processing an electronic message, the method comprising:
receiving exclusion criteria associated with the electronic message;
identifying group members associated with the group alias address;
processing the exclusion criteria to identify at least one excluded group member to exclude from receiving the electronic message and at least one included group member to receive the electronic message; and
blocking the at least one excluded group member from receiving the electronic message.

10. The method of claim 9 further comprising transmitting the electronic message to the at least one included group member.

11. The method of claim 9 wherein identifying the at least one excluded group member further comprises:
querying a directory server based on the exclusion criteria to identify the at least one excluded group member.

12. The method of claim 9 further comprising:
removing the exclusion criteria from the electronic message; and
transmitting the electronic message to the at least one included group member.

13. The method of claim 9 wherein:
the electronic message comprises a recipient field;
the at least one included group member having an individual electronic message address; and
the method further comprises replacing the group alias address in the recipient field of the electronic message with the individual electronic message address of the at least one included group member.

14. The method of claim 9 wherein:
the electronic message comprises a recipient field;
the at least one included group member having an individual electronic message address; and
the method further comprising:
determining whether the at least one included group member includes less than a predetermined number of group members; and
replacing the group alias address in a recipient field of the electronic message with the individual electronic message address of the at least one included group member in response to a determination that the at least one included group member includes less than the predetermined number of group members.

15. The method of claim 9 wherein the electronic message further comprises an exclude field for displaying an electronic message address of the at least one excluded group member, and the method further comprising:
inserting the electronic message address of the at least one excluded group member into the exclude field.

16. The method of claim 9 wherein each group member has an individual electronic message address, and the method further comprises:
identifying at least one group member from the group members associated with the group alias address based on the exclusion criteria;
transmitting the at least one group member to a sender of the electronic message; and
receiving user input from the sender specifying the at least one excluded group member which is selected from the at least one group member transmitted to the sender.

17. A method for processing electronic messages, the method comprising:
receiving user input specifying a group alias address for an electronic message, the group alias address identifying group members associated with the group alias address;
receiving user input specifying exclusion criteria associated with the electronic message, with the exclusion criteria identifying at least one excluded group member to be excluded from receiving the electronic message;
transmitting the electronic message addressed to the group alias address to an electronic message server; and
transmitting the exclusion criteria to the electronic message server.

18. The method of claim 17 wherein the group alias address corresponds to a list of group members associated with the group alias address, with each group member having an individual electronic message address, the exclusion criteria comprising information which is not an electronic message address of at least one of the group members.

19. The method of claim 17 wherein transmitting the exclusion criteria further comprises transmitting the exclusion criteria to the electronic message server as part of the electronic message transmission.

20. The method of claim 17 wherein the group alias address comprises a plurality of group members associated with the group alias address, and the method further comprises:
querying the electronic message server based on the exclusion criteria for at least one group member from the plurality of group members associated with the group alias address;
displaying the at least one group member to a sender of the electronic message;
receiving user input from the sender specifying at least one excluded group member selected from the at least one group member transmitted to the sender; and
transmitting the at least one excluded group member to the electronic message server, the electronic message server transmitting the electronic message to the group members and blocking the at least one excluded group member from receiving the electronic message.
